(19) United States
(12) Patent Application Publication
(10) Pub. No.: US 2014/0025226 A1
(43) Pub. Date: Jan. 23, 2014

(54) Method and Apparatus for Charging Station Guidance

(71) Applicant: Ford Global Technologies, LLC, Dearborn, MI (US)

(72) Inventors: Elizabeth Profitt Brown, Plymouth, MI (US); Kelly Lee Zechel, Plymouth, MI (US); Joseph Paul Rork, Plymouth, MI (US); Brian Petersen, Beverly Hills, MI (US); Edward Andrew Pleet, Livonia, MI (US)

(73) Assignee: Ford Global Technologies, LLC, Dearborn, MI (US)

(21) Appl. No.: 14/036,322

(22) Filed: Sep. 25, 2013

Related U.S. Application Data
(63) Continuation of application No. 12/985,492, filed on Jan. 6, 2011.

(51) Int. Cl. G01C 21/26

(52) U.S. Cl. CPC G01C 21/26
USPC 701/1

(57) ABSTRACT

A computer-implemented method, executable by a vehicle associated computing system, includes receiving a request for display of local refueling points. The method also includes determining current coordinates of vehicle and determining one or more fuel point locations within a defined map range. The method additionally includes displaying a map display containing the current vehicle location and the location of the one or more fuel point locations.

### CROSS-REFERENCE TO RELATED APPLICATIONS

This application is a continuation of U.S. application Ser. No. 12/985,492 filed Jan. 6, 2011, the disclosure of which is hereby incorporated in its entirety by reference herein.

### TECHNICAL FIELD

The illustrative embodiments generally relate to a method and apparatus for charging station guidance.

### BACKGROUND

In the world of constant connection in which we live, people are becoming accustomed to the concept that they can obtain a virtually limitless supply of information at a moment's notice. Between computers, smart phones, wireless cellular networking and numerous wireless hotspots, it is rare, especially in a city environment, to find a place where an internet connection cannot be obtained.

Vehicles have even evolved to the point where they can provide information to a driver. For example, vehicle navigation systems will often have a screen included therewith, which allows a driver to see navigation directions while driving. Other information related to a vehicle may also be available on these screens, such as oil change warnings, radio settings, and additional data.

With these navigation systems, a driver will typically select a destination. The navigation system then provides a route from the vehicle's current location to the destination point. Some navigation systems will provide directions, other systems may additionally provide a visual map of where the vehicle is traveling.

### SUMMARY

In a first illustrative embodiment, a computer-implemented method, executable by a vehicle associated computing system, includes receiving a request for display of local refueling points. The exemplary method also includes determining current coordinates of vehicle and determining one or more fuel point locations within a defined map range. The illustrative method additionally includes displaying a map display containing the current vehicle location and the location of the one or more fuel point locations.

In a second illustrative embodiment, a computer readable storage medium, stores instructions that, when executed by a vehicle associated computing system, cause the system to execute a method including receiving a request for display of local refueling points. The exemplary method also includes determining current coordinates of vehicle and determining one or more fuel point locations within a defined map range. The exemplary method further includes displaying a map display containing the current vehicle location and the location of the one or more fuel point locations.

In a third illustrative embodiment, a computer-implemented method, executable by a vehicle associated computing system, includes detecting a vehicle charging condition. The method further includes determining if a charging point having a location similar to a vehicle present location exists in a charging point database. The method additionally includes conditional on the non-existence of the charging point, adding a charging point to the database, and associating the vehicle present location as a charging point location.

### BRIEF DESCRIPTION OF THE DRAWINGS

FIG. 1 shows an illustrative example of a vehicle associated computing system;

FIG. 2A shows an illustrative representation of a vehicle route map;

FIG. 2B shows an illustrative embodiment of a process for causing charging point display;

FIG. 3 shows an illustrative process for showing one or more charging points;

FIG. 4 shows an illustrative embodiment of a process for defining a map display range;

FIG. 5 shows an illustrative embodiment of a process for coding stations for display;

FIG. 6 shows an illustrative embodiment of a station information display;

FIG. 7 shows an illustrative embodiment of a process for station guidance management;

FIG. 8 shows an illustrative embodiment of a process for providing driver guidance; and

FIG. 9 shows an illustrative embodiment of a process for dynamically adding a charging point.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Due to the relative recency of the introduction of electric vehicles (EVs) that at least partially draw power from the power grid (through, for example, a plug-in connection) few commercial charging stations exist for public use (at least compared to the prolific nature of gas stations). Accordingly, it may be difficult for users to simply find a convenient recharging point along a route. E.g., an EV driver may not simply be able to assume that they will soon run across a recharging station if they keep traveling along a route.

In the illustrative embodiments, however, a navigation display also may include one or more recharging points. These points can be commercial charging stations, user entered charging points, or may even be dynamically added to a database based on a detection that recharging has previously occurred at a point. Charging points may be displayed for a variety of reasons, including, but not limited to, a detection that a vehicle is low on fuel, a detection that a vehicle may not have sufficient fuel to reach a destination, a request by a user for display, a constant display, etc.

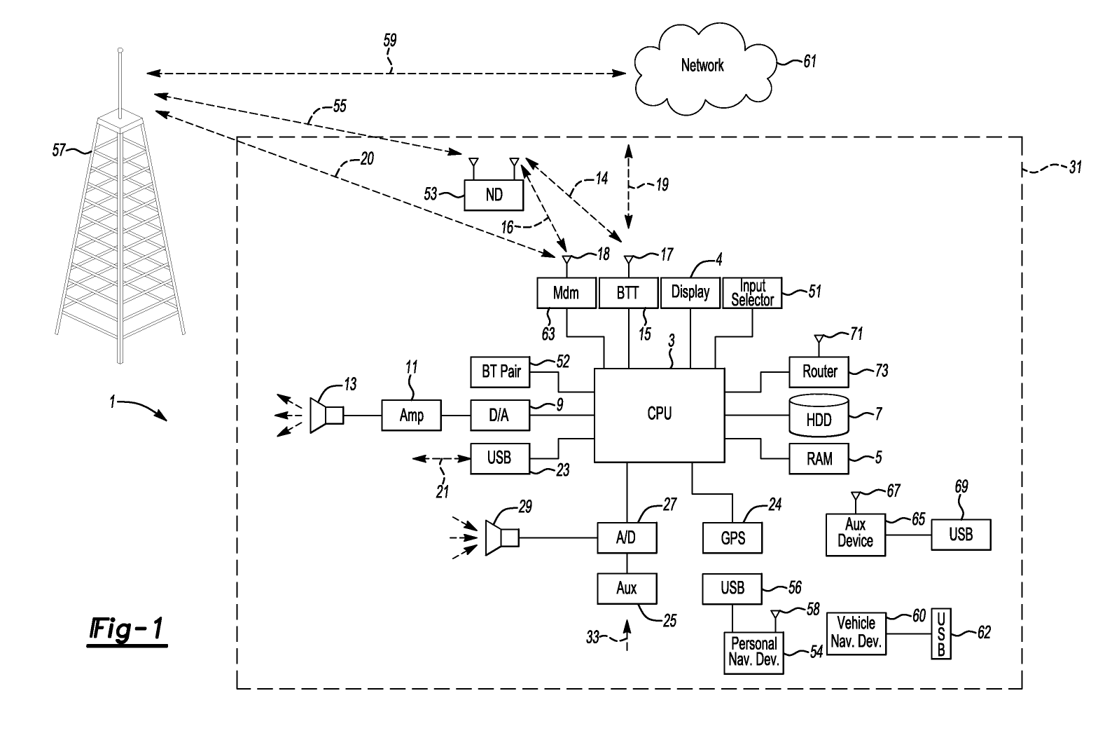

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device).

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example).

If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58; or a vehicle navigation device 60, having a USB 62 or other connection, an onboard GPS device 24, or remote navigation system (not shown) having connectivity to network 61.

Further, the CPU could be in communication with a variety of other auxiliary devices 65. These devices can be connected through a wireless 67 or wired 69 connection. Also, or alternatively, the CPU could be connected to a vehicle based wireless router 73, using for example a WiFi 71 transceiver. This could allow the CPU to connect to remote networks in range of the local router 73. Auxiliary device 65 may include, but are not limited to, personal media players, wireless health devices, portable computers, and the like.

Although the following describes the invention in terms of illustrative embodiments, these examples are provided for non-limiting illustrative purposes only, and are not intended to limit the scope of the invention thereto.

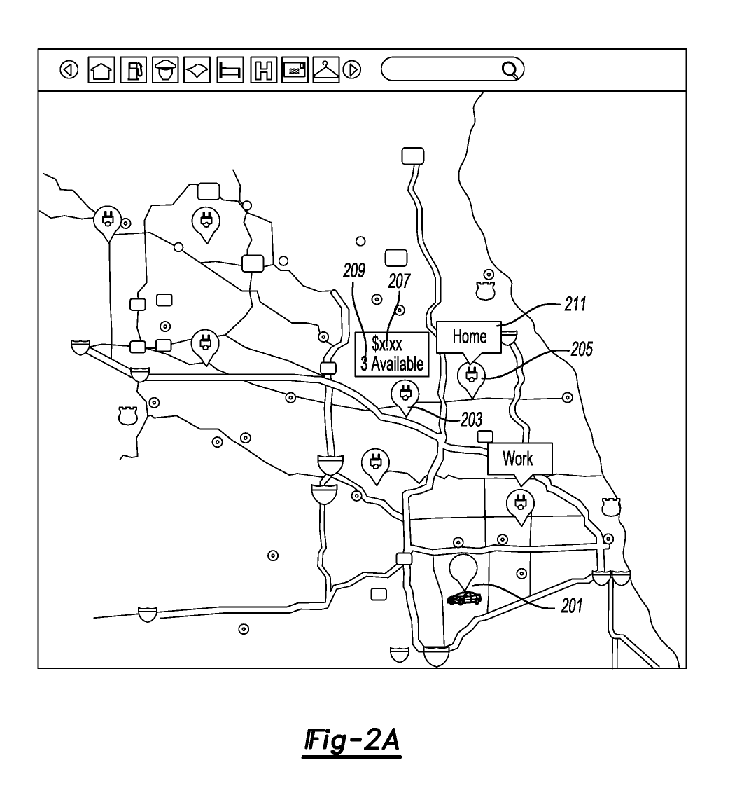

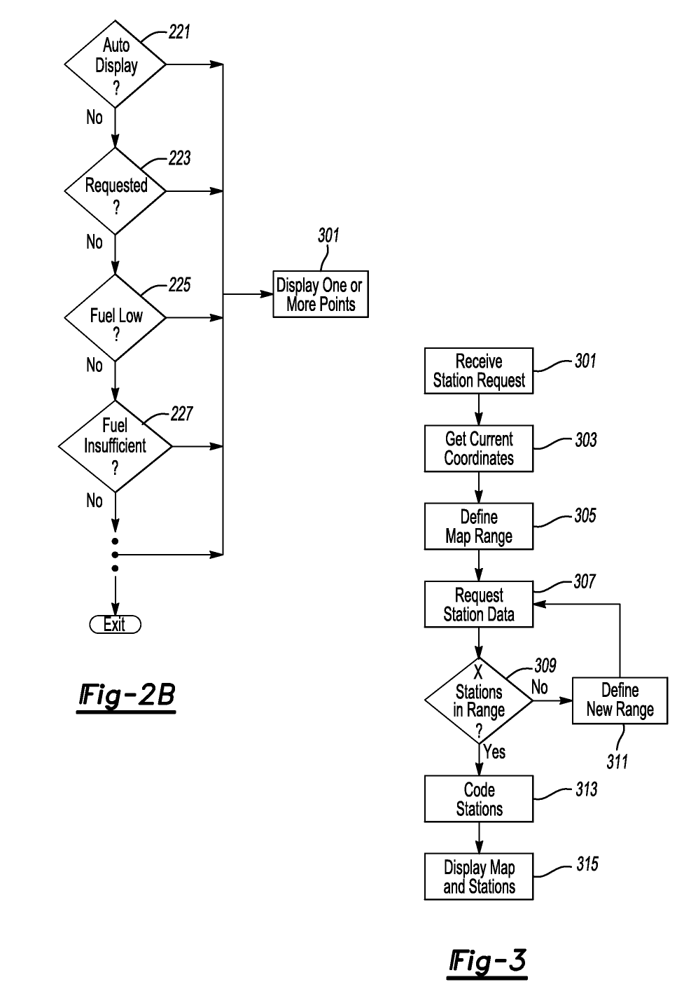

FIG. 2 shows an illustrative representation of a vehicle route map. In this illustrative embodiment, a display (such as, but not limited to, a nav display, a wireless device display, etc.) capable of communication with a routing system (e.g., without limitation, a vehicle computing system, a remote server, a wireless device, etc.) shows a route to be traveled (or simply a map, which may or may not be localized around a vehicle location) including one or more charging points 200. Charging points include, but are not limited to, commercial charging stations, user entered charging points, dynamically added charging points, etc.

In this illustrative embodiment, the display includes the current position of the vehicle 201. An icon or other representation may be used to inform the driver of the current location of the vehicle. This display, in this illustrative embodiment, also includes a plurality of charging points 203, 205. In this example, point 203 is a commercial charging point, and point 205 is a user-entered charging point. The display may or may not distinguish between the two types of charging points.

In this illustrative embodiment, additional information is included in the display with reference to the charging points. Although not necessary, in at least one embodiment this information may provide the user with more charging point information. With respect to the charging station, a price 207 and a number of available charging slots 209. These are just a few examples of the many types of suitable information that may be shown in conjunction with a charging point display (if any is shown at all). Additionally, the charging station may be color coded (or otherwise coded in a displayed manner). For example, charging stations (and/or other points) that are within a likely reachable range, may be coded in a first color (or manner). Stations that are questionably reachable may be coded in a second color (or manner). Stations that are out of range may be in a third color (or manner). Coding may also be used to distinguish between different types of charging points.

With respect to the user-entered coding point 205, additional data may also be displayed 211 or not displayed. In this particular embodiment, a point-identifier “Home” is displayed in conjunction with the user entered point, although the point may have no associated information. As with the commercial point, the user-entered point may be coded in some manner to indicate additional data (such as, but not limited to, reachability, type, etc.).

FIG. 2A shows an illustrative embodiment of a process for causing charging point display. In this illustrative process, several non-limiting examples of reasons for causing charging point display are shown. These decisions are intended to be exemplary and not to represent the only reasons charging points may be displayed. Charging points may be displayed for any suitable reason.

In this example, the process first checks to see if there is a setting set such that charging points should always be displayed 221. For example, if a driver frequently drives in unfamiliar areas with infrequent charging points, the driver may always want to know if a charging station is proximate. A constant display will provide this information (although the driver could always just repetitively request the points, in another embodiment).

FIG. 3 shows an illustrative process for showing one or more charging points. In this illustrative embodiment, a vehicle associated computing system (which could be, for example, without limitation, a vehicle computing system, a wireless device in communication with a vehicle computing system, a remote server in communication with a vehicle computing system, etc.) receives a request to display one or more charging points 301 (or processes an “always on” state for charging points).

In this illustrative embodiment, the one or more points to be displayed are in some relative proximity to the current vehicle location, although the point(s) could be along the route, near a destination, in a particular area, etc. Since, in this embodiment, the points are in proximity to the vehicle, current vehicle coordinates are obtained 303.

Also, in this illustrative embodiment, a map range may be defined 305. This could be a range around the vehicle, a range around a request point, and could be determined by a predefined number, a dynamically alterable number, a number relating to the proximity of a first charging point (e.g., without limitation, if a first point was six miles distant from the request location, the range may be accordingly set at or above six miles), etc. A fixed range may also be used, and in such a scenario points may only be displayed if they are present within the range (in another embodiment, the range may be scaled up from a starting point until a first point is found). In still another illustrative embodiment, the range for point requests may be determined by the total remaining distance to a destination, and this entire range may or may not be displayed (e.g., without limitation, the range may be equal to twenty miles, the distance to a destination, and the display may only show six miles).

In this embodiment, once the range is determined, the vehicle associated computing system requests station data within the range 307. Station data could also be requested prior to determining the range, if, for example, the range is based on the proximity of the closest one or more charging points.

Station data can include, but is not limited to, commercial charging stations, user input charging stations, dynamically stored charging points, etc. The data may be stored in one or more locations, including, but not limited to, a database located at the vehicle, a database remote from the vehicle, the Internet, a database local to the vehicle associated computing system (VACS), etc. Also, requested coordinates may be directionally requested. In other words, if a current vehicle heading and/or destination, for example, is known, then it may be desirable to request points selectively. Selective point requests may include, but are not limited to, points in a direction a vehicle is heading, points in a range centered between a vehicle location and a destination, points in a range centered about a point a certain distance from the vehicle in the direction the vehicle is heading, etc. Points may also be requested no more than a predefined or user input deviance from a known route. Any suitable point determination algorithm is considered to be within the scope of the present invention.

Once the station data is requested, the VACS checks to see if there are X stations within the range 309. In this illustrative embodiment, the range will continually change until at least a certain number of stations can be displayed 311. This is just one suitable example of determining a range. X can be any number (including 0) and may be predefined or user defined.

In this embodiment, once a suitable number of stations or points have been found, the VACS may code the points 313. In one illustrative embodiment, all charging points may be displayed in the same manner and using similar identifiers, but in another illustrative embodiment, the points may have different information displayed therewith and may also be coded based on, for example, without limitation, proximity to vehicle, type (commercial, private, etc.), price, etc.

Also, in this embodiment, the points (within a display range) may then be displayed 315. In this embodiment, a map is also displayed in conjunction with the points. In another illustrative embodiment, it may be possible to display a list of points and a user may select one or more points from this list for display and/or routing.

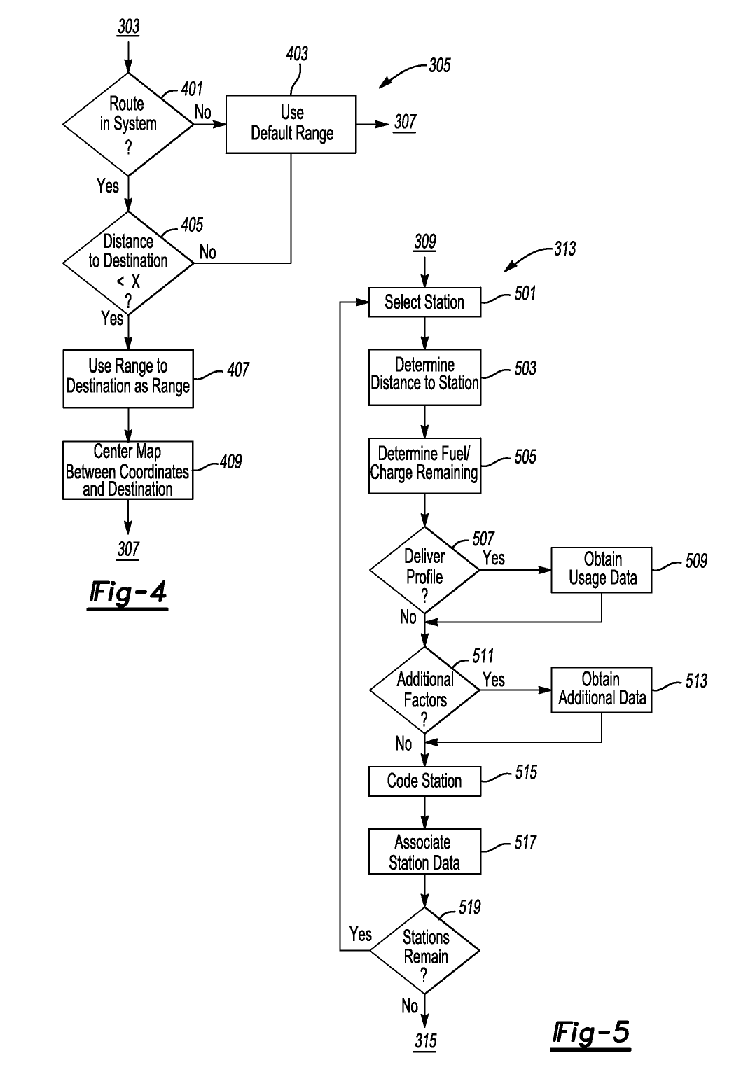

FIG. 4 shows an illustrative embodiment of a process for defining a map display range. In this illustrative embodiment, a predefined range is used unless a distance to destination is less than a predefined range. Again, this is but one example of an illustrative process for determining a range in which to retrieve points, and any suitable process may be used if a determination of range is desired.

In this illustrative embodiment, current vehicle coordinates have been determined 303 (if, for example, the display is to be determined based on vehicle coordinates). In this embodiment, the VACS checks to see if a vehicle route has been programmed into a routing system 401. If there is no route, a default range is used in this embodiment 403.

If there is a route present for the vehicle, the VACS determines if a distance to the destination is less than X (the default range, in this embodiment). If the range to the destination is greater than the default range, then, in this illustrative example, the default range may be used. Otherwise, the range to the destination may be used in this illustrative example 407.

Also, in this illustrative embodiment, the display may be centered between the current coordinates and the destination 409, such that the range may define, in one embodiment, the display including both the current destination and the current vehicle location.

In this embodiment, once the display is set, the process continues to step 307 to obtain point data. Since a “max” range has already been determined (as the range to the destination is the range), if the range determination process includes such steps as range expansion 311, these steps may be avoided in the instance that the range to destination is used at the defined range.

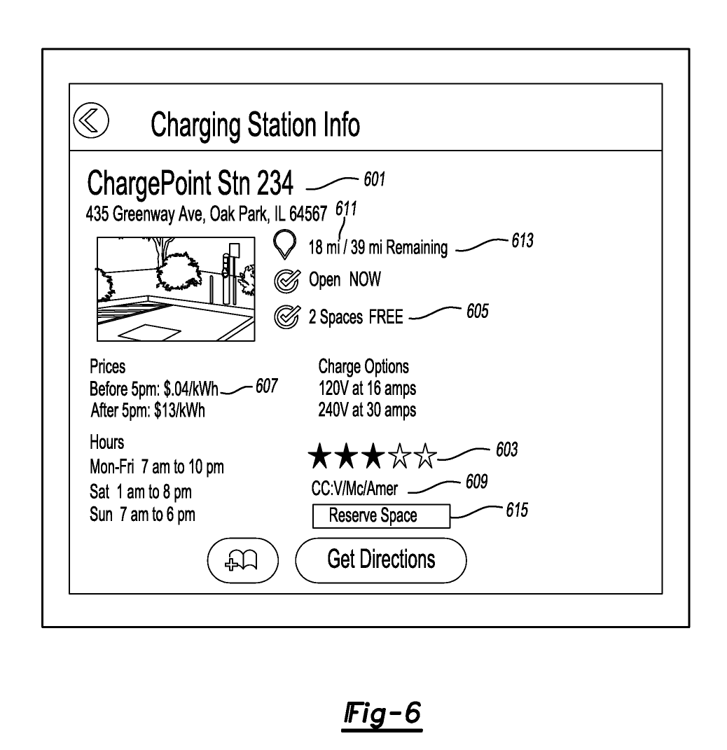

FIG. 5 shows an illustrative embodiment of a process for coding stations for display. In this illustrative embodiment, stations are coded including one or more pieces of data that may delineate between different features of points. Non-limiting examples of point data include, but are not limited to, proximity to a vehicle, relative cost of power, private vs. commercial charging points, etc.

In this illustrative embodiment, the VACS selects a first point for coding from one or more points considered for display 501. Once a station has been selected, in this illustrative embodiment, the VACS determines a distance from the current vehicle coordinates to the station 503. If, for example, the vehicle was not displayed on the display, this determination may or may not be done. For example, if the user requested one or more points within a proximity of a crossroads, the distance determination may be skipped entirely or may be determined based on the proximity to the crossroads (city center, etc.). Additionally, if no coding is used, this entire process for coding may be skipped. Other suitable coding processes may also be employed.

In this illustrative embodiment, since one of the non-limiting coding examples is coding for reachability of the station (e.g., can the vehicle reach the station), the VACS determines (through communication with a vehicle system, for example) how much fuel remains 505 (fuel may include both gasoline and electricity, assuming that the vehicle uses both types of fuel. If only one type of fuel is used, then remaining fuel may simply correspond to that fuel type). Additionally, in this illustrative embodiment, the VACS may determine if a profile is associated with a driver 507.

A driver profile, in this illustrative embodiment, is a profile that is identified by, for example, without limitation, use of a particular key/fob or pairing of a particular phone. Different drivers may have different driving styles, and thus have different average fuel consumption for particular types of driving. Driver profiles may contain other information as well, such as, but not limited to, preferences for coding stations, etc. For example, without limitation, a particular driver may wish the vehicle to consider a “questionably reachable” station to be a station where less than ten projected driving miles remain, whereas a second driver may wish the vehicle to consider the same category to exist when less than fifteen projected driving miles remain.

If there are driver profile factors to consider, in this illustrative embodiment, that data is obtained 509. In this embodiment, there also may be additional factors to consider. For example, without limitation, weather, traffic, etc. may adjust a projected range. Even if the vehicle has twenty projected miles of fuel remaining under ideal driving conditions, it may only have, for example, five projected miles remaining under sever traffic conditions.

If there are additional factors to consider and/or if additional factors are to be used, the system may also gather the additional factors for consideration 513. Once the appropriate additional data and/or driver usage data (if desired) are gathered, the VACS may code the station appropriately 515. In this illustrative example, the coding correlates to a coding for reachability and/or station type, although these are only two non-limiting examples of data that may be represented by coding. Once the point has been coded, in this illustrative embodiment, point data to be displayed may be associated with the point 517. Although this data may not be displayed and/or associated, non-limiting examples of data that may be displayed include type (private, commercial, etc.), price, actual distance, user-ratings (either individual user or crowdsourced), etc.

If any stations remain for consideration, in this embodiment, the system repeats the process for those stations 519.

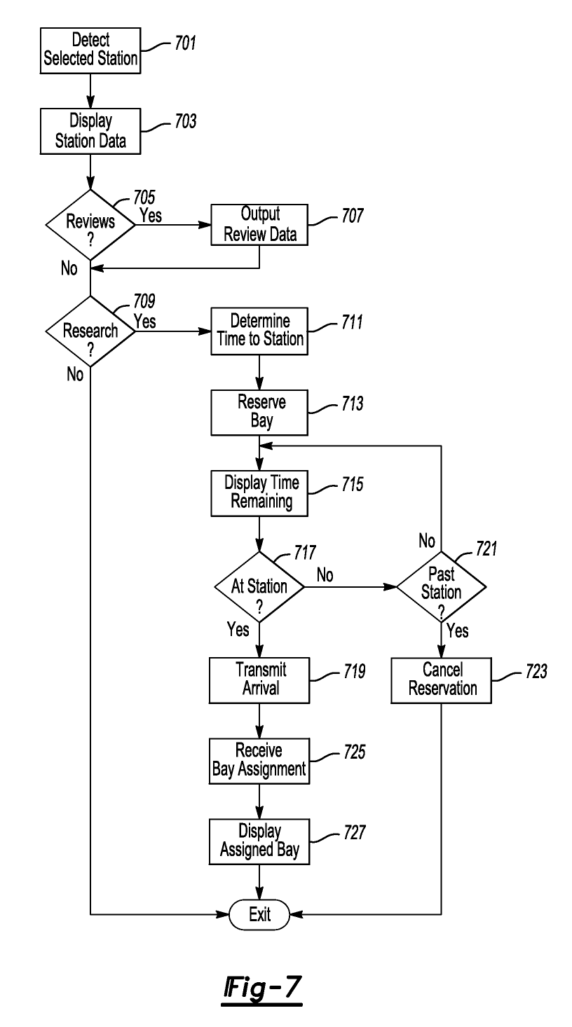

FIG. 6 shows an illustrative embodiment of a station information display. In this illustrative embodiment, a particular charging station is identified in a pop-up display 601.

In addition to a station name, a variety of additional information may be present. This information may include, but is not limited to, the information shown in FIG. 6.

In this example, the information includes user ratings 603 which may adjust based on user input. The information may also include a number of free spaces 605 and pricing information 607. Again, this information may adjust dynamically based on current data.

This exemplary display also includes payment types 609, current mileage to station 611 and mileage remaining 613 and an option to reserve a space at the station.

FIG. 7 shows an illustrative embodiment of a process for station guidance management. This is but one illustrative example of certain types of guidance that may or may not be provided to a driver regarding one or more stations. In this non-limiting example, a driver may have data related to a selected station displayed, and, also, may reserve a station bay for a projected arrival time. Station reservations may or may not be permitted at a particular station, but if they are allowed and can be interacted with through the VACS, for example, it may be possible for a driver to reserve a slot while traveling. Since EVs may take much longer than gasoline vehicles to refuel, stations may accept and honor reservations. These are just a few non-limiting examples of driver guidance that may occur.

In this illustrative embodiment, the driver selects a station. In one non-limiting example, this selection may be done via, for example, a touch screen, such as, but not limited to, a navigation screen. Other suitable selection methods are also contemplated and considered to be within the scope of the invention.

Once a station selection has been detected by the VACS 701, the illustrative embodiment may display station data 703. This display could include, for example, data such as that shown with respect to FIG. 6 or other suitable data.

Additionally, in this illustrative embodiment, there may be reviews of stations available that may or may not be selected by a user for viewing (or may be automatically displayed). If there are selected reviews available 705, then the system may display the reviews for a vehicle occupant to peruse 707. Review data may be output through other means as well, such as verbal output.

Additionally or alternatively, in this illustrative embodiment, there may be an option to reserve a station bay. If the reservation option is available and is selected 709, the VACS may, in this embodiment, determine the time remaining before the station is reached 711. This determination may be used to determine if reservations are possible (if, for example, stations only accept reservations when a vehicle is within a certain distance and/or time proximity).

In this illustrative process, the VACS may also reserve the station bay 713 and display the time remaining until the projected arrival 715. If, for example, a bay can only be held for a certain amount of time past a reservation arrival time, the display of the time remaining may assist a user in knowing whether a reservation should be rescheduled.

If the user has not yet reached the station 717, the system may check to see if the user has traveled past the station (or past the station more than a certain distance) 721. If the user has not reached or passed the station, the time remaining display may continue. If the user has passed by the station (either by a time, distance, or simply passed it along a route), the VACS may cancel the reservation 723. The VACS may also ask the user if cancellation is desired prior to cancellation.

If the vehicle arrives at the station 717, in this illustrative example, the VACS may transmit an arrival notification to the station 719. The system may transmit the notification if, for example, the station cancels reservations after a time limit elapses, and, in this manner, ensure the station knows that the vehicle has arrived. Of course, the system may also forego transmission if desired or if unneeded.

In this illustrative example, once the arrival notification has been transmitted, the system may receive a bay assignment 725. In this illustrative example, “bay” is used to refer to a charging station identification number or other identification of an assigned charging spot. Once the assignment has been received, the VACS may display the assigned bay so the user can determine where to charge the vehicle 727.

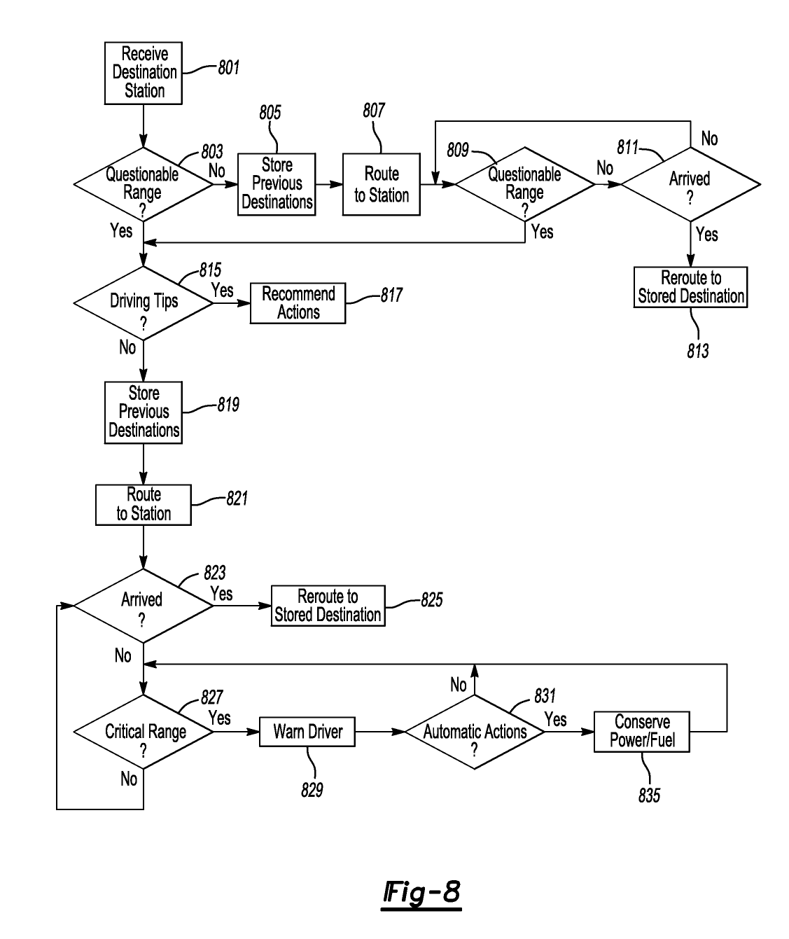

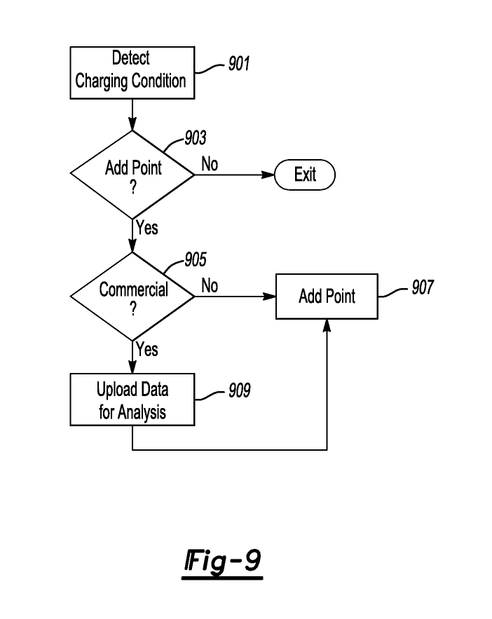

FIG. 8 shows an illustrative embodiment of a process for providing driver guidance. In this illustrative example, some additional non-limiting types of driver guidance are displayed. In this example, a user may be re-routed to a selected station. Additionally or alternatively, the user may be given driving tips if the likelihood of reaching the station is questionable and/or critical.

In this example, the VACS receives a destination station selected, for example, by a user for re-routing 801. After receiving the destination, in this illustrative example, the system checks to see if the likelihood of reaching the station is “questionable” 803. If the likelihood reaching the station is more than questionable (i.e., the user is likely to reach the station without issue), the previous destination (if any) is stored 805. In this example, the destination is stored so that it can be restored after the detour to the charging station is completed.

The illustrative process then reroutes the vehicle to the selected charging station 807. In this example, since the likelihood of reaching the station may shift from likely to questionable at some point during the driving process, the process continues to check if this shift has occurred 809 until the driver arrives at the station 811. For example, without limitation, the driver may have a projected remaining range of thirty miles and the station may only be several miles away. But, due to an unexpected delay, rerouting or other factors that may alter projected fuel usage, the driver may find the fuel running low before reaching the station. Thus, in this example, the system monitors whether or not the user is likely to reach the station without taking measures to conserve fuel, if needed 809.

Once the user arrives at the station, in this example, the VACS or routing system re-routes the user back to the previous destination that was stored at step 805. It is also possible that the user was re-routed without having the previous destination pre-stored.

In this embodiment, if the likelihood of reaching the station ever becomes questionable, the system may offer the user one or more driving tips 815 that are recommended for fuel conservation. These tips may include, for example, without limitation, turning off unneeded systems, optimizing regenerative braking, re-routing around traffic conditions, etc. If the user requests driving tips, and/or if the tips are available, the system may display general tips and/or tips that are specific to the current trip 817.

If the vehicle has not yet been rerouted to a station at step 807, and if the previous location has not yet been stored at step 805, the system may now store the previous destination 819 and re-route the user to a selected station 821.

In this example, there are three types of probability of reaching a station, likely, questionable and critical. Many tierings are possible, this is just one example of how the likelihood of reaching the station can be quantified. In this embodiment, the system checks to see if a likelihood of reaching the station has changed from questionable to critical, unless the user has arrived at the destination 823. Once the user arrives at the destination, the VACS or routing system re-routes the user to a stored destination 825.

If the likelihood of reaching the destination becomes critical 827, the system may warn the driver 829 of the current situation. In this example, the system also provides the driver with the option to take one or more automatic options to maintain fuel 831. If the user elects to have the system take automatic action, one or more systems that are non-critical and consuming power may be disabled, for example 835. Other suitable fuel conserving actions may also be additionally or alternatively taken. Once critical actions have been taken (or declined), this process may be skipped in further process loops until the station is reached.

FIG. 9 shows an illustrative embodiment of a process for dynamically adding a charging point. Since all charging stations may not be logged in a retrievable manner, for example, private stations, such as a user's home, or new commercial stations, it may be useful to have stations automatically added to a point database. In this illustrative example, the VACS detects that the vehicle is currently charging 901. The location of the vehicle may then be compared to known local charging locations to determine if a charging point should be added 903. If point addition is appropriate and/or user elected 903, the system may query the user for additional point data.

For example, without limitation, in this illustrative example, the system may ask the user if the point is a commercial station 905. Once the point type has been identified 905 (if desired), the system may simply add the point 909 if the point is a private point. If the point is a commercial point, the system may additionally upload the point location for crowdsourcing analysis and possible addition to a public database 907. For example, if a sufficient number of users identify a point as a new commercial point, then that point may be added to a public point database even before the point identifies itself for data retrieval. In this manner, sufficient data from multiple users can quickly and accurately identify new commercial charging points in an area.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method, executable by a vehicle associated computing system, comprising:
detecting a vehicle charging condition;
determining if a charging point having a location within a predetermined proximity to a vehicle present location exists in a charging point database; and
conditional on a non-existence of the charging point, adding a charging point to the database, and associating the vehicle present location as a charging point location.

2. The method of claim 1, further comprising:
asking a user to identify a charging point type; and
associating the identified charging point type with the charging point.

3. The method of claim 2, wherein the charging point type is a commercial identification.

4. The method of claim 3, wherein the charging point is further added to a public charging point database on a basis of the commercial identification.

5. The method of claim 4, wherein the charging point is further added to a public charging point database on an additional basis of multiple, independent user identification of the present location as a commercial charging point.

6. The method of claim 2, wherein the charging point type is a non-commercial identification.

7. A system comprising:
a processor configured to:
detect a vehicle charging condition;
determine if a charging point having a location within a predetermined proximity to a vehicle present location exists in a charging point database; and
conditional on a non-existence of the charging point, add a charging point to the database, and associating the vehicle present location as a charging point location.

8. The system of claim 7, wherein the processor is further configured to:
ask a user to identify a charging point type; and
associate the identified charging point type with the charging point.

9. The system of claim 8, wherein the charging point type is a commercial identification.

10. The system of claim 9, wherein the charging point is further added to a public charging point database on a basis of the commercial identification.

11. The system of claim 10, wherein the processor is further configured to instruct the charging point to be added to a public charging point database on an additional basis of multiple, independent user identification of the present location as a commercial charging point.

12. The system of claim 8, wherein the charging point type is a non-commercial identification.

13. A non-transitory computer-readable storage medium storing instructions that, when executed by a processor, cause the processor to perform a method comprising:
detecting a vehicle charging condition;
determining if a charging point having a location within a predetermined proximity to a vehicle present location exists in a charging point database; and
conditional on a non-existence of the charging point, adding a charging point to the database, and associating the vehicle present location as a charging point location.

14. The computer-readable storage medium of claim 13, the method further comprising:
asking a user to identify a charging point type; and
associating the identified charging point type with the charging point.

15. The computer-readable storage medium of claim 14, wherein the charging point type is a commercial identification.

16. The computer-readable storage medium of claim 15, wherein the charging point is further added to a public charging point database on a basis of the commercial identification.

17. The computer-readable storage medium of claim 16, wherein the charging point is further added to a public charging point database on an additional basis of multiple, independent user identification of the present location as a commercial charging point.

18. The computer-readable storage medium of claim 14, wherein the charging point type is a non-commercial identification.
